(19) United States
(12) Patent Application Publication
(10) Pub. No.: US 2006/0266916 A1
(43) Pub. Date: Nov. 30, 2006

(54) Imprint lithography template having a coating to reflect and/or absorb actinic energy

(75) Inventors: Michael N. Miller, Austin, TX (US); Edward B. Fletcher, Austin, TX (US); Nicholas A. Stacey, Austin, TX (US); Michael P. C. Watts, Austin, TX (US); Ian M. McMackin, Austin, TX (US)

Correspondence Address: MOLECULAR IMPRINTS, PO BOX 81536, AUSTIN, TX, 78708-1536, US

(73) Assignee: Molecular Imprints, Inc.

(21) Appl. No.: 11/136,897

(22) Filed: May 25, 2005

(51) Int. Cl. B29C 35/12

(52) U.S. Cl. 249/134; 249/135; 425/174.4

(57) ABSTRACT

The present invention is directed towards a template, transmissive to energy having a predetermined wavelength, having first and second opposed sides and features a coating disposed thereon to limit the volume of the template through which the energy may propagate. In a first embodiment, the template includes, inter alia, a mold, having a plurality of protrusions and recessions, positioned on a first region of the first side; and a coating positioned upon a second region of the first side, with the coating having properties to block the energy from propagating between the first and second opposed sides.

### BACKGROUND OF THE INVENTION

The field of the invention relates generally to micro-fabrication techniques. More particularly, the present invention is directed to a template suitable for use in imprint lithography.

The prior art is replete with examples of micro-fabrication techniques. One particularly well known micro-fabrication technique is imprint lithography. Imprint lithography is described in detail in numerous publications, such as United States published patent application 2004/0065976 filed as U.S. patent application Ser. No. 10/264,960, entitled “Method and a Mold to Arrange Features on a Substrate to Replicate Features having Minimal Dimensional Variability”; United States published patent application 2004/0065252 filed as U.S. patent application Ser. No. 10/264,926, entitled “Method of Forming a Layer on a Substrate to Facilitate Fabrication of Metrology Standards”; and United States published patent application 2004/0046271 filed as U.S. patent application Ser. No. 10/235,314, entitled “Method and a Mold to Arrange Features on a Substrate to Replicate Features having Minimal Dimensions Variability”; all of which are assigned to the assignee of the present invention. The fundamental imprint lithography technique as shown in each of the aforementioned published patent applications includes formation of a relief pattern in a polymerizable layer and transferring a pattern corresponding to the relief pattern into an underlying substrate. To that end, a template, having a mold, is employed. The mold is spaced-apart from, and in superimposition with, the substrate with a formable liquid present therebetween. The liquid is patterned and solidified to form a solidified layer that has a pattern recorded therein that is conforming to a shape of the mold. The substrate and the solidified layer may then be subjected to processes to transfer, into the substrate, a relief image that corresponds to the pattern in the solidified layer.

One manner in which to locate the polymerizable liquid between the template and the substrate is by depositing the liquid on the substrate as one or more droplets, referred to as a drop dispense technique. Thereafter, the polymerizable liquid is concurrently contacted by both the template and the substrate to spread the polymerizable liquid therebetween. Actinic energy is impinged upon the polymerizable liquid to form the solidified layer. It is desirable to expose only a portion of the liquid to the actinic energy to form the solidified layer to minimize undesirable patterning of the polymerizable liquid.

Thus, there is a need to provide a template to control exposure of the polymerizable liquid to the actinic energy during imprint lithographic processes.

### SUMMARY OF THE INVENTION

The present invention is directed towards a template, transmissive to energy having a predetermined wavelength, having first and second opposed sides and features a coating disposed thereon to limit the volume of the template through which the energy may propagate. In a first embodiment, the template includes, inter alia, a mold, having a plurality of protrusions and recessions, positioned on a first region of the first side; and a coating positioned upon a second region of the first side, with the coating having properties to block the energy from propagating between the first and second opposed sides. These and other embodiments of the present invention are discussed more fully below.

### BRIEF DESCRIPTION OF THE DRAWINGS

FIG. 1 is a cross-sectional view of a template, disposed opposite to a substrate, with patterned imprinting material disposed therebetween, in accordance with the prior art;

FIG. 2 is a cross-sectional view of the patterned imprinting layer shown in FIG. 1, having a conformal layer disposed thereon in accordance with the prior art;

FIG. 3 is a simplified top down view of the conformal layer shown in FIG. 2, in accordance with the prior art;

FIG. 4 is a cross-sectional view of a template, in accordance with the present invention;

FIG. 5 is a detailed view of the template shown in FIG. 4, having a coating positioned thereon;

FIG. 6 is a cross-sectional view of the coating shown in FIG. 4, in accordance with an alternate embodiment;

FIG. 7 is a perspective view of the template shown in FIG. 4, in accordance with the present invention;

FIG. 8 is a perspective view of the template shown in FIG. 4, in accordance with a first alternate embodiment of the present invention;

FIG. 9 is a cross-sectional view of the template shown in FIG. 8 taken along lines 9-9;

FIG. 10 is a perspective view of the template shown in FIG. 4, in accordance with a second alternate embodiment of the present invention;

FIG. 11 is a cross-sectional view of the template shown in FIG. 4, in accordance with a third alternate embodiment of the present invention;

FIGS. 12-13 show a first method of forming the coating upon the template;

FIGS. 14-16 show a second method of forming the coating upon the template;

FIGS. 17-18 show a third method of forming the coating upon the template; and

FIG. 19 shows a fourth method of forming the coating upon the template.

### DETAILED DESCRIPTION OF THE INVENTION

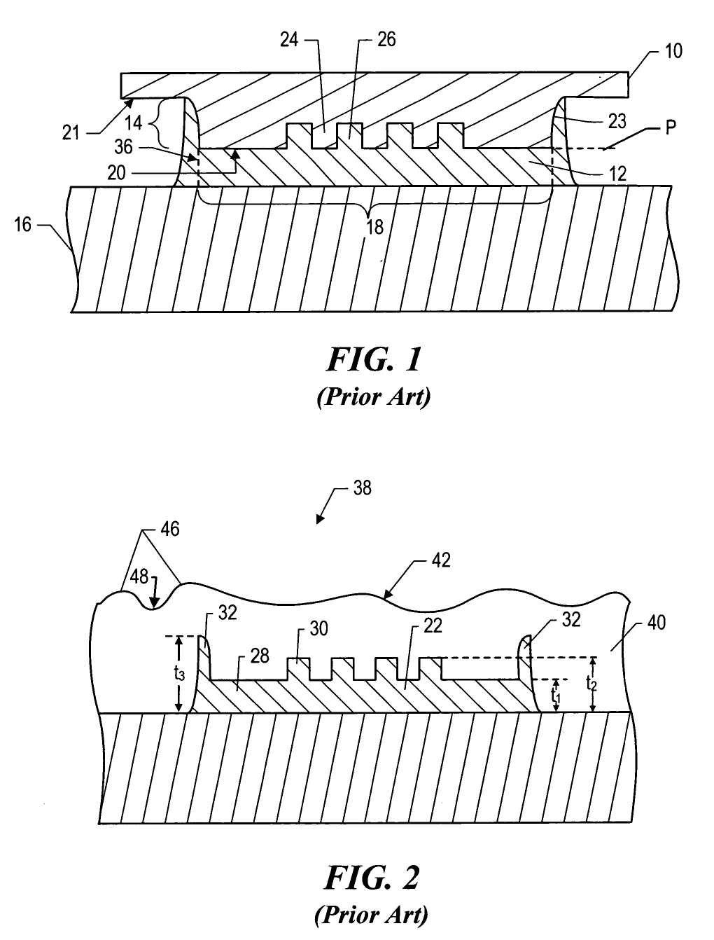

Referring to FIG. 1, a template 10 is shown in contact with imprinting material 12 being disposed between a mold 14 and a substrate 16 in furtherance of patterning imprinting material 12. To that end, mold 14 is spaced-apart from substrate 16 with imprinting material 12 substantially filling a volumetric gap defined between mold 14 and a region 18 of substrate 16 in superimposition therewith. Thereafter, imprinting material 12 is solidified by exposing the same to an actinic component. In this manner, the shape of a surface 20 of mold 14, facing imprinting material 12, is recorded therein by formation of solidified imprinting layer 22, shown in FIG. 2.

Referring to FIGS. 1 and 2, surface 20 of mold 14 is patterned by inclusion of a plurality of protrusions 24 and recessions 26. The apex portion of each of protrusions 24 lies in a common plane, P. It should be understood, however, that surface 20 may be substantially smooth, without protrusions 24 and recessions 26, if not planar.

The actinic component employed to solidify imprinting material 12 may be any known, depending upon the composition of imprinting material 12. Exemplary compositions for imprinting material 12 are disclosed in U.S. patent application Ser. No. 10/789,319, filed Feb. 27, 2004, entitled “Composition for an Etching Mask Comprising a Silicon-Containing Material,” which is incorporated by reference herein in it's entirety. Furthermore, imprinting material 12 may comprises an ultraviolet curable hybrid sol-gel such as Ormoclad® available from Microresist Technology GmbH located in Berlin, Germany. As a result, the actinic component employed is typically energy comprising ultraviolet wavelengths, and template 10 and mold 14 are fabricated from a material that is substantially transparent to the actinic component, e.g., fused silica, quartz, and the like. However, other actinic components may be employed, e.g., thermal, electromagnetic, visible light, infrared, and the like.

Imprinting material 12 may be deposited upon either substrate 16 and/or template 10 employing virtually any known technique, dependent upon the composition employed. Such deposition techniques include but are not limited to, chemical vapor deposition (CVD), physical vapor deposition (PVD), spin-coating, and drop dispense techniques. After formation of solidified imprinting layer 22, mold 14 is separated therefrom, and solidified imprinting layer 22 remains on substrate 16. Solidified imprinting layer 22 includes residual regions 28 having a thickness t₁ and projections 30 having a thickness t₂, with t₂ being greater than t₁. Control of the dimensions of features recorded in solidified imprinting layer 22 is dependent, inter alia, upon the volume of imprinting material 12 in superimposition with region 18.

One attempt to confine imprinting material 12 to the volumetric gap includes forming mold 14 on template 10 as a mesa. To that end, mold 14 extends from a recessed surface 21 of template 10 and terminates in plane P. Sidewall 23 functions to assist confining imprinting material 12 within the volumetric gap due to the lack of capillary attraction between imprinting material 12 and mold 14 outside the volumetric gap. Specifically, sidewall 23 is provided with sufficient length to reduce the probability that capillary attraction between recessed surface 21 and imprinting material 12 occurs.

Occasionally during the imprinting process, imprinting material 12 may extrude beyond the volumetric gap so as to lie outside of region 18. This may be due to, inter alia, fluid pressure generated in imprinting material 12 while being compressed between substrate 16 and mold 14. Further, the fluid pressure may cause a sufficient quantity of imprinting material 12 to extrude beyond the volumetric gap so that capillary attraction between this material and recessed surface 21 occurs. As a result, formed, proximate to the periphery of region 18, are extrusions 32. Extrusions 32 have a thickness t₃ that may be several orders of magnitude larger than thicknesses t₁ and t₂, depending upon the spacing between recessed surface 21 and substrate 16. For example, thickness t₃ may be 2 μm-15 μm. The presence of extrusions 32 may be problematic. For example, imprinting material 12 contained in extrusions 32 may not completely cure when exposed to the actinic component. This may result in imprinting material 12 accumulating at a periphery 36 of mold 14. Additionally, upon separation of mold 14 from solidified imprinting layer 22, imprinting material 12 in extrusions 32 may spread over the remaining portions of substrate 16 lying outside of the volumetric gap. Additionally, extrusions 32 may become cured, which can result in same remaining on substrate 16 as part of solidified imprinting layer 22. Any of the aforementioned effects of extrusions 32 can generate unwanted artifacts during subsequent imprinting processes.

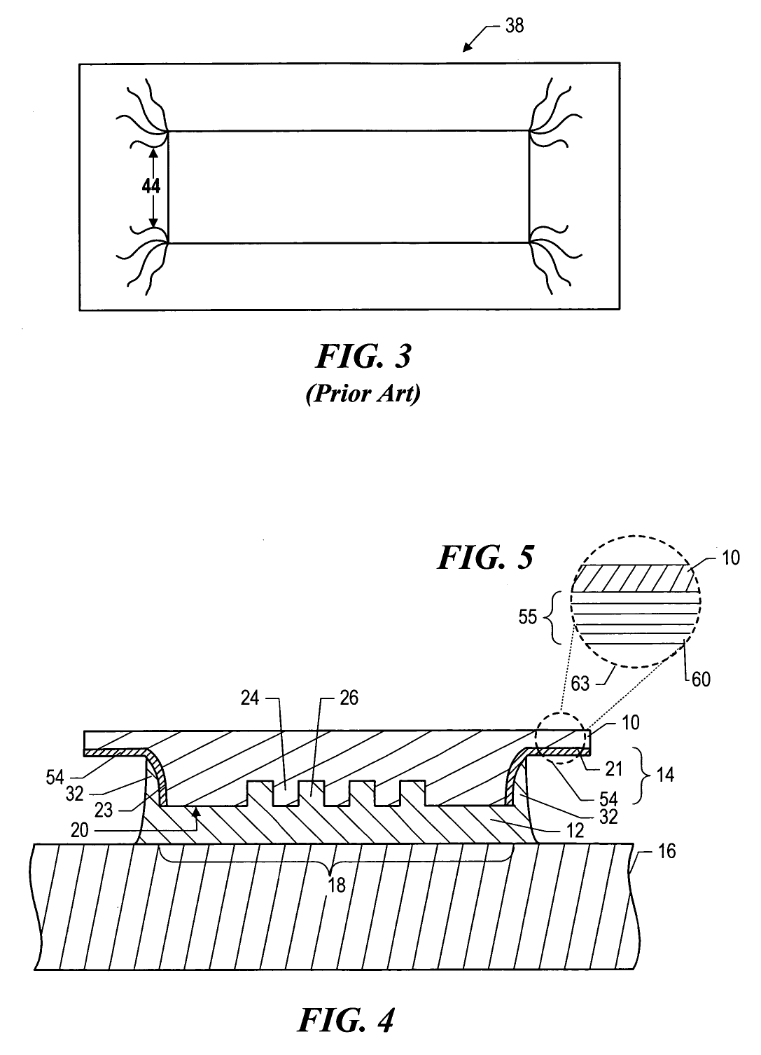

Referring to FIGS. 2 and 3, were extrusions 32 partially cured, for example, control of the thickness of subsequently disposed layers becomes problematic. This is shown by formation of multi-layered structure 38 resulting from the deposition of a conformal layer 40 upon solidified imprinting layer 22. In the present example, conformal layer 40 is formed employing spin-on techniques as discussed in U.S. patent application Ser. No. 10/789,319, filed on Feb. 27, 2004 entitled “Composition for an Etching Mask Comprising a Silicon-Containing Material.” The presence of extrusions 32, however, reduces the planarity of the surface 42 ordinarily expected from spin-on deposition of conformal layer 40. The presence of extrusions 32 results in the formation of deleterious artifacts, such as thickness variations, in conformal layer 40. These deleterious artifacts are present as protrusions in surface 42 and are generally referred to as comets 44. Comets 44 are, typically, undesirable artifacts, because the same produce peaks 46 and troughs 48 in surface 42. As a result, surface 42 is provided with a roughness that hinders patterning very small features. Similar roughness problems in subsequently formed surfaces arise in the presence of artifacts generated by extrusions 32.

To avoid the deleterious artifacts, the present invention reduces, if not prevents, actinic radiation from impinging upon extrusions 32. As mentioned above, extrusions 32 may become cured when exposed to actinic radiation, and therefore, cause generation of unwanted artifacts during subsequent imprinting processes. To that end, a coating 54, shown in FIG. 4, may be selectively positioned upon template 10 such that only desired portions of imprinting material 12 are exposed to actinic radiation while excluding other portions of imprinting material 12 from exposure to actinic radiation. Coating 54, shown in FIG. 4, minimizes, if not prevents, actinic radiation from impinging upon portions of imprinting material 12 in superimposition with coating 54, and more specifically, extrusions 32, by reflecting and/or absorbing the actinic radiation impinged thereupon, and thus, the aforementioned imprinting material 12, or extrusions 32, will not become cured, which is desired. As a result, the imprinting material 12 contained within extrusions 32 may thus evaporate and substantially be removed from being disposed upon substrate 16. The evaporation of imprinting material 12 of extrusions 32 may depend on, inter alia, the volatility of imprinting material 12.

Furthermore, in subsequent steps employed in semiconductor processing, imprinting material 12 contained within extrusions 32 may be exposed to a developer chemistry, wherein the developer chemistry may remove any excess imprinting material 12 in extrusions 32 that remains disposed upon substrate 16 after the aforementioned evaporation.

Furthermore, coating 54, shown in FIG. 4, has properties associated therewith such that the same may sustain exposure to cleaning chemistries employed in semiconductor processing steps to remove contamination from template 10 without the necessity for reapplication of the same after exposure to the aforementioned cleaning chemistries, described further below. As a result, the efficiency of the manufacturing process employed to pattern imprinting material 12 is increased as reapplication of coating 54, shown in FIG. 4, is not necessitated.

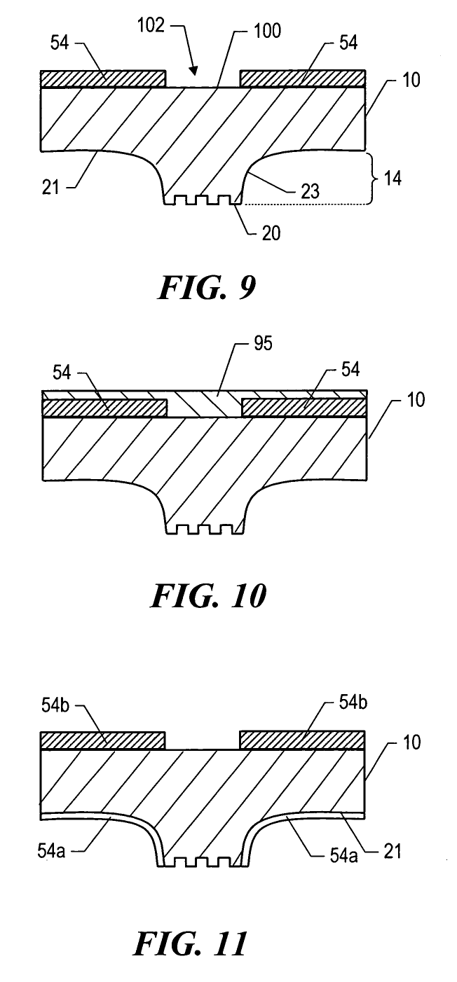

Coating 54 may be positioned upon template 10 in a plurality of locations. In a first embodiment, coating 54 may be positioned upon recessed surface 21 and sidewall 23 of template 10, as shown in FIGS. 4 and 7. However, coating 54 may be positioned upon a backside 100 of template 10, as shown in FIGS. 8 and 9, described further below.

Referring to FIGS. 4 and 5, in a first embodiment, coating 54 comprises a multilayer film stack 55. Multilayer film stack 55 comprises alternating layers of at least two differing materials each having an index of refraction associated therewith. The index of refraction of each of the differing materials may be substantially different, however, in a further embodiment, the indices of refraction of each of the differing materials may be substantially the same.

Multilayer film stack 55 may be tuned to reflect and/or absorb desired wavelengths of the actinic radiation. The wavelengths of the actinic radiation reflected and/or absorbed by multilayer film stack 55 is dependent upon, inter alia, the number of layers comprising multilayer film stack 55, the thickness of each of the layers comprising multilayer film stack 55, and the indices of refraction associated with each layer comprising multilayer film stack 55. To that end, the above-mentioned properties of multilayer film stack 55 may be selected such that the same may be employed to reflect and/or absorb ultraviolet (UV) and visible light. In a first example, multilayer film stack 55 comprises alternating layers of a metal oxide and silicon dioxide (SiO₂), with outer layer 60 comprising silicon dioxide (SiO₂). The metal oxide may be selected from a group including, but is not limited to, tantalum oxide (Ta₂O₅), titanium oxide (TiO₂), and other similar metal oxides. In a further example, multilayer film stack 55 comprises alternating layers of a metal oxide, with outer layer 60 comprising a metal oxide. The metal oxide may be selected from a group including, but is not limited to, Tantala (Ta₂O₅), Zirconia (ZrO₂), and other similar metal oxides. Outer layer 60 is employed to provide multilayer film stack 55 with a chemical resistance to cleaning chemistries employed in subsequent semiconductor processing steps to remove contamination from template 10. Outer layer 60 provides multilayer film stack 55 with chemical resistance to substantially all cleaning chemistries employed in semiconductor processing excepting cleaning chemistries that are alkaline or contain hydrofluoric acid (HF). Furthermore, comprising outer layer 60 in multilayer film stack 55 minimizes surface energy variations that may occur between surface 20 and recessed surface 21 and sidewalls 23. Outer layer 60 may have a thickness of approximately 20 nm.

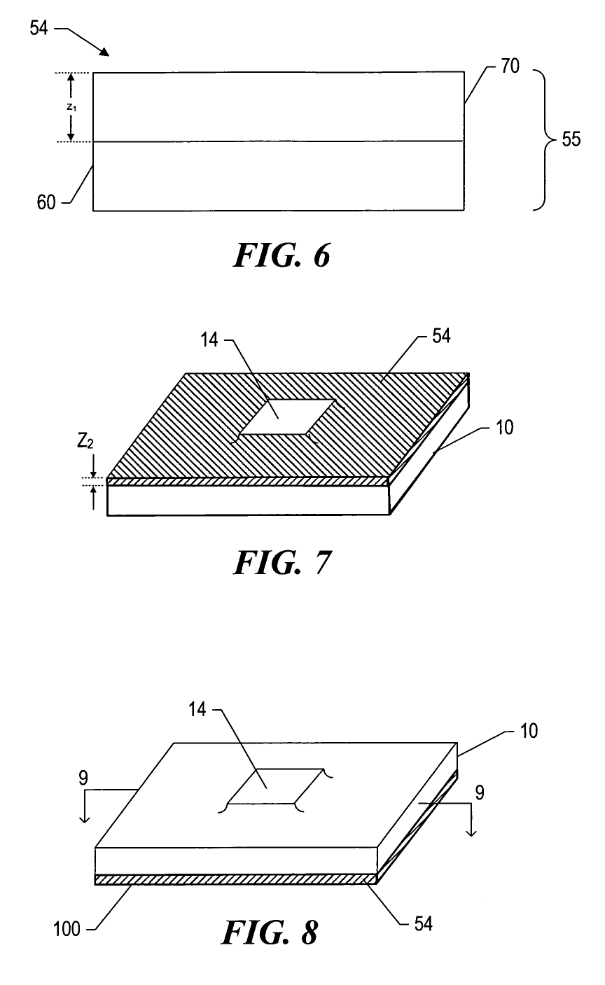

Referring to FIGS. 4 and 6, in a further embodiment, multilayer film stack 55 may comprise two layers, a first layer 70 and outer layer 60. First layer 70 may be positioned between template 10 and outer layer 60. First layer 70 may comprise a metal having a thickness ‘z₁’ associated therewith. The magnitude of thickness ‘z₁’ is established such that multilayer film stack 55 substantially reflects and/or absorbs the actinic radiation impinged thereupon, with such radiation including ultraviolet (UV) and visible light. First layer 70 may comprise a metal selected from a group including, but is not limited to, aluminum (Al), silver (Ag), and gold (Au). Thickness ‘z₁’ may lie in a range of approximately 250 nm to 1 μm, however, the thickness ‘z₁’ may be dependent upon, inter alia, the type of metal comprising first layer 70. In a first example, employing aluminum (Al) as first layer 70, thickness ‘z₁’ may have a magnitude of approximately 600 nm.

Referring to FIG. 7, in a further embodiment, coating 54 may comprise a single layer having a thickness ‘z₂’ associated therewith. The magnitude of thickness ‘z₂’ is established such that coating 54 substantially reflects and/or absorbs the actinic radiation impinged thereupon. In a first example, coating 54 may comprise an inert metal selected from a group including, but is not limited to, niobium (Nb) and tantalum (Ta). To that end, employment of an inert metal to comprise coating 54 abrogates the necessity of an additional layer to protect the same from exposure to cleaning chemistries employed in subsequent semiconductor processing steps to remove contamination from template 10. Coating 54 may be chemically resistant to such cleaning chemistries comprising a mixture of hydrogen peroxide (H₂O₂) and sulfuric acid (H₂SO₄). In a second example, coating 54 may comprise a metal selected from a group including, but is not limited to, aluminum (Al), silver (Ag), and gold (Au). As a result of coating 54 comprising a metal, coating 54 may be chemically resistant to such cleaning chemistries as oxygen plasma and other solvent cleaning chemistries. Thickness ‘z₂’ may lie in a range of approximately 250 nm to 1 μm, however, the thickness ‘z₂’ may be dependent upon, inter alia, the type of metal comprising coating 54. In a first example, employing aluminum (Al) as coating 54, thickness ‘z₂’ may have a magnitude of approximately 600 nm.

Referring to FIGS. 8 and 9, as mentioned above, coating 54 may be positioned upon template 10 in a plurality of positions. To that end, in a second embodiment, coating 54 may be positioned upon backside 100 of template 10. More specifically, coating 54 may be positioned upon portions of backside 100 in superimposition with recessed area 21 and sidewalls 23, forming a window 102 in superimposition with surface 20 of mold 14. In a further embodiment, a silicon dioxide (SiO₂) layer 95 may be deposited upon backside 100 of template 10, as shown in FIG. 10.

Referring to FIG. 11, in a further embodiment, coating 54 may be positioned upon backside 100 and recessed surface 21 and sidewall 23 concurrently. More specifically, coating 54 may be positioned upon recessed surface 21 and sidewall 23, shown as coating 54a, and portions of backside 100 in superimposition with recessed area 21 and sidewalls 23, shown as coating 54b. Each of coatings 54a and 54b may comprise differing embodiments of the above-mentioned embodiments for coating 54; however, each of coatings 54a and 54b may comprise the same embodiments of the above-mentioned embodiments.

Referring to FIGS. 1 and 9, in a further embodiment, the pattern formed in imprinting material 12 may be dependent upon, inter alia, the positioning of coating 54 upon template 10. More specifically, coating 54 may be selectively positioned upon backside 100 of template 10 such that window 102 facilitates transmission of the actinic radiation to a portion of the imprinting material in superimposition with a desired portion of mold 14. As a result, only the aforementioned portion of imprinting material 12 may have recorded therein a shape of surface 20 of mold 14. The desired portion of mold 14 may be less than an entirety of mold 14.

Coating 54 may be deposited upon template 10 in a plurality of methods, described generally below, wherein Deposition Sciences, Inc. of Santa Rosa, Calif. may provide such coatings in this fashion. Templates employed may be available from Dupont Photomasks, Inc. of Round Rock, Tex., Dai Nippon Printing Co. of Tokyo, Japan, and Photronics, Inc. of Brookfield, Conn.

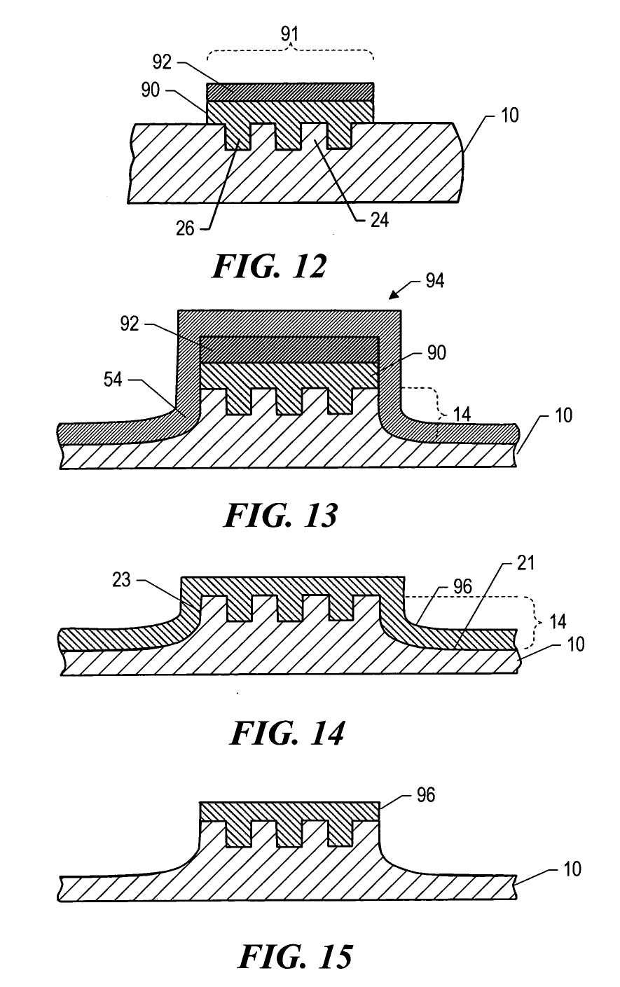

Referring to FIGS. 12 and 13, in a first example, coating 54 may be applied to template 10 prior to formation of mold 14 on template 10. To that end, as shown in FIG. 12, a chrome layer 90 and a photoresist layer 92 may be formed on a portion 91 of template 10, with portion 91 comprising protrusions 24 and recessions 26. Template 10 may be exposed to a buffered oxide etch (BOE) to form mold 14 thereon, with mold 14 being in superimposition with portion 91. Coating 54 may be subsequently applied to template 10, forming multilayered structure 94, shown in FIG. 13.

Referring to FIGS. 4 and 13, to remove chrome layer 90, photoresist layer 92, and a portion of coating 54 in superimposition with mold 14, template 10 may be exposed to a chrome etching chemistry. As a result, coating 54 may be selectively positioned upon recessed surface 21 and sidewall 23 of template 10, shown in FIG. 4, which is desired. The chrome etching chemistry may comprise perchloric acid (HClO₄) and ceric ammonium nitrate (NH₄)₂Ce (NO₃)₆.

Referring to FIGS. 4 and 14, in a second example, coating 54 may be applied to template 10 subsequent to formation of mold 14 on template 10. To that end, as shown in FIG. 14, a photoresist layer 96 may be formed on template 10. Portions of photoresist layer 96 in superimposition with recessed surface 21 and sidewall 23 may be removed, as shown in FIG. 15.

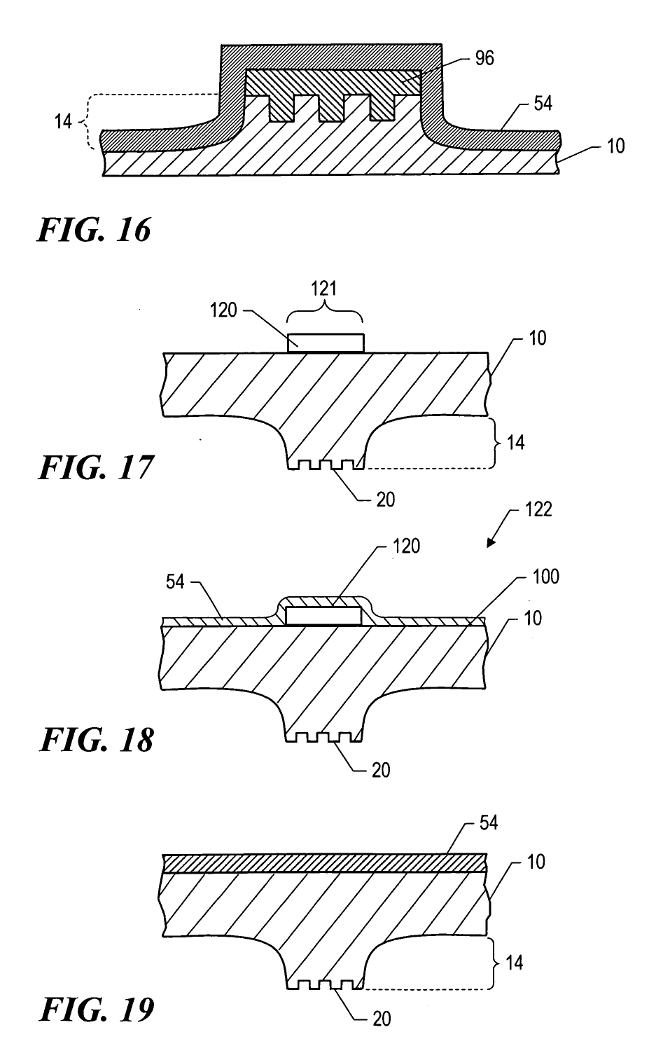

Referring to FIG. 16, after removing the aforementioned portions of photoresist layer 96, coating 54 may be applied to template 10. Photoresist layer 96 and portions of coating 54 in superimposition with mold 14 may be removed by exposing template 10 to acetone (C₃H₆O). As a result, coating 54 may be selectively positioned upon recessed surface 21 and sidewall 23 of template 10, as shown in FIG. 4, which is desired.

Referring to FIGS. 17 and 18, in a first example to form coating 54 upon backside 100 of template 10, a photoresist layer 120 may be formed on a portion 121 of template 10, with portion 121 being in superimposition with surface 20 of mold 14. Coating 54 may be applied to template 10, forming multilayered structure 122, as shown in FIG. 18. Photoresist layer 120 and portions of coating 54 in superimposition with portion 121 may be removed such that coating 54 may be selectively positioned upon portions of backside 100 in superimposition with recessed surface 21 and sidewall 23, as shown in FIGS. 8 and 9. To remove the aforementioned portions of coating 54, the same may be subjected to a buffered oxide etch (BOE) solution containing hydrofluoric acid (HF) or a fluorine containing dry etch such as trifluoromethane (CHF₃) or sulfur fluoride (SF₆) reactive ion etch (RIE). To remove photoresist layer 120, coating 54 may be removed in a manner such that portions of photoresist layer 120 may be exposed, with such portions being subjected to acetone (C₃H₆O) to remove photoresist layer 120. In a second example to expose a portion of photoresist layer 120 such that the same may be subjected to acetone (C₃H₆O), coating 54 may be directionally deposited upon template 10.

Referring to FIG. 19, in a second example to form coating 54 upon backside 100 of template 10, coating 54 may be deposited on substantially the entire backside 100. Coating 54 may then be masked to define an area in superimposition with recessed 21 and sidewall 23, as shown in FIGS. 8 and 9, with the aforementioned area of coating 54 being subjected to an etching chemistry to remove the same. To remove the aforementioned portions, coating 54 may be subjected to a buffered oxide etch (BOE) solution containing hydrofluoric acid (HF) or a fluorine containing dry etch such as trifluoromethane (CHF₃) or sulfur fluoride (SF₆) reactive ion etch (RIE).

The embodiments of the present invention described above are exemplary. Many changes and modifications may be made to the disclosure recited above, while remaining within the scope of the invention. Therefore, the scope of the invention should not be limited by the above description, but instead should be determined with reference to the appended claims along with their full scope of equivalents.

What is claimed is:

1. A template having first and second opposed sides and being transmissive to energy having a predetermined wavelength, said template comprising:
a mold, having a plurality of protrusions and recessions, positioned on a first region of said first side; and
a coating positioned upon a second region of said first side, with said coating having properties to block said energy from propagating between said first and second opposed sides.

2. The template as recited in claim 1 wherein said second region lies outside of said first region.

3. The template as recited in claim 1 wherein said coating is further positioned upon said second side.

4. The template as recited in claim 1 wherein said coating is further positioned upon portions of said second side in superimposition with said second region.

5. The template as recited in claim 1 wherein said coating comprises a multilayer film stack having alternating layers of silicon dioxide and metal oxide, with an outermost layer of said multilayer film stack comprising silicon dioxide.

6. The template as recited in claim 1 wherein said coating comprises a multilayer film stack having alternating layers of differing metal oxides.

7. The template as recited in claim 1 wherein said coating comprises a multilayer film stack having first and second layers, said first layer positioned between said template and said second layer, with said first layer comprising metal and said second layer comprising silicon dioxide.

8. The template as recited in claim 1 wherein said coating comprises metal.

9. A template comprising:
a recessed surface;
a mold extending from a plane terminating proximate to said recessed surface, defining a periphery, with said recessed surface extending transversely to said periphery; and
a coating positioned upon said periphery and said recessed surface, said coating having proprieties to block energy having a predetermined wavelength from penetrating therethrough.

10. The template as recited in claim 9 wherein said template comprises a back surface spaced-apart from said plane a first distance and said recessed surface a second distance, with said coating further positioned upon said back surface.

11. The template as recited in claim 9 wherein said template comprises a back surface spaced-apart from said plane a first distance and said recessed surface a second distance, with said coating further positioned upon portions of said back surface in superimposition with said periphery and said recessed surface.

12. The template as recited in claim 9 wherein said coating comprises a multilayer film stack having alternating layers of silicon dioxide and metal oxide, with an outermost layer of said multilayer film stack comprising silicon dioxide.

13. The template as recited in claim 9 wherein said coating comprises a multilayer film stack having alternating layers of differing metal oxides.

14. The template as recited in claim 9 wherein said coating comprises a multilayer film stack having first and second layers, said first layer positioned between said template and said second layer, with said first layer comprising metal and said second layer comprising silicon dioxide.

15. The template as recited in claim 9 wherein said coating comprises metal.

16. A template having first and second opposed sides and being transmissive to energy having a predetermined wavelength, said template comprising:
a mold positioned upon said first side; and
a coating, positioned upon a first region of said second side, having properties to block said energy from propagating between said first and second opposed sides, said second side including a second region, substantially absent of said coating, in superimposition with a desired region of said mold.

17. The template as recited in claim 16 wherein said coating comprises a multilayer film stack having alternating layers of silicon dioxide and metal oxide, with an outermost layer of said multilayer film stack comprising silicon dioxide.

18. The template as recited in claim 16 wherein said coating comprises a multilayer film stack having alternating layers of differing metal oxides.

19. The template as recited in claim 16 wherein said coating comprises a multilayer film stack having first and second layers, said first layer positioned between said template and said second layer, with said first layer comprising metal and said second layer comprising silicon dioxide.

20. The template as recited in claim 16 wherein said coating comprises metal.
